(19) United States
(12) Patent Application Publication
(10) Pub. No.: US 2006/0165129 A1
(43) Pub. Date: Jul. 27, 2006

(54) System and method for adapting transmission rate of a multimedia streaming server using a "virtual clock"

(75) Inventors: Qiong Li, Tappan, NY (US); Mihaela Van Der Schaar, Martinez, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/538,108

(22) PCT Filed: Dec. 10, 2003
(86) PCT No.: PCT/IB03/05855

§ 371 Date: Jun. 8, 2005

Related U.S. Application Data
(60) Provisional application No. 60/432,974, filed on Dec. 12, 2002.

(51) Int. Cl. H04J 3/06

(52) U.S. Cl. 370/503

(57) ABSTRACT

A so-called “Virtual Clock” with varying frequency is provided for used by a multimedia streaming server to adapt its transmission rate dynamically to changing network conditions. The “Virtual Clock” system and method of the present invention compensates for a potential limitation of the Internet Real-time Transmission Protocol (RTP), that stamps every packet it delivers with a timestamp and expects the server using this timestamp to schedule the transmission of this particular packet accordingly. Consequently, the transmission rate is pre-determined by the encoded multimedia content when RPT is used. Using the “Virtual Clock” of the present invention, the streaming server has a mechanism to overcome this RTP limitation and can conduct transmission rate adaptation in a way that can balance the bandwidth requirement of the content with the bandwidth availability of the network.

The present invention relates to multimedia streaming over a network More particularly, the present invention relates to adapting the transmission rate of streamed multimedia to changing network conditions. Most particularly, the present invention introduces the concept of a “Virtual Clock” as a mechanism for a streaming server to perform dynamic transmission rate adaptation in a way that balances the bandwidth requirement of the content to be transmitted with the bandwidth available of the Internet.

The design and implementation of state-of-the-art streaming servers generally includes a constant-frequency clock that is essentially the same as the computer clock of the computer hosting the server application. Packet scheduling and transmission are carried out according to the constant rate of this clock. The transmission rate is pre-determined only by the encoded content. This is evidenced in the implementation of Darwin Streaming Server, that was developed by Apple and its source code that is openly available to public, see, for example, http://developer.apple.com/darwin/projects/streaming/.

Since the available bandwidth of packet switching networks is time-varying, it is necessary for a streaming application to be able to adjust its transmission rate according to network conditions. Currently available techniques for rate adaptation include layer switching and selective layer subscription.

In layer switching, the server maintains multiple copies of the same content but encoded with different qualities and therefore different bit rates. The server can dynamically switch between these copies (or layers) to achieve rate adaptation.

In selective layer subscription, the server only store one copy of the content encoded by a scalable coding scheme such as Fine-Granular Scalability (FGS) or other similar scheme. A scalable coding scheme generates multiple accumulative layers that can be sequentially added up at the receiver side to get better and better decoded quality. In real time, the server only transmits the sub-set of the layers that have been explicitly requested, i.e., subscribed to, by the receiver. When the receiver changes its layer subscriptions according to perceived network conditions, the rate adaptation is achieved. The latter scheme is widely proposed for multicast and commonly referred to as receiver-driven layer multicasting.

The limitation of the above techniques is their adaptation granularity. Both schemes can only achieve coarse-grained rate adaptation. In other words, they can only adapt rates to a level that is not frequent enough. However, experiments have shown that network conditions can change dramatically over relatively small time scales due to dynamic background traffic or temporary degradation of a wireless link.

An adaptive playout technique has been proposed. In this technique, the receiver dynamically changes video playout speed to avoid buffer starvation or overflow in the event of network congestion. However, this technique is proposed only for the receiver side, and has no effect on packet transmission over the network. In fact, a combination of the present invention with this proposed adaptive playout strategy may result in a more efficient and robust streaming technique.

Thus, a method that can achieve fine-grained rate adaptation in streaming applications is highly desirable. The present invention provides a “Virtual Clock” having variable frequency that can be used by a multimedia streaming server to dynamically adapt its transmission rate to changing network conditions. This “Virtual Clock” compensates for a potential limitation of the Internet Real-time Transmission Protocol (RTP), that stamps every packet it delivers with a timestamp and expects the server using this timestamp to schedule the transmission of this particular packet. Consequently, the transmission rate is pre-determined by the encoded multimedia content when RTP is used. By providing a “Virtual Clock” according to the present invention, the multimedia streaming server has a mechanism to overcome this RTP limitation and perform transmission rate adaptation in a way that balances the bandwidth requirement of the content and the bandwidth availability of the network.

The “Virtual Clock” of the present invention addresses the issue of fine-grained rate adaptation. A streaming server needs a clock to schedule the transmission of time-stamped RTP packets. If the clock moves forward at a constant rate, then the transmission rate will be pre-determined by the RTP timestamps that are normally generated at coding stage.

By contrast, a “Virtual Clock” according to the present invention, adopts a time-varying frequency. When such a clock is used by a server to schedule transmissions, it provides a variable to be added to the transmission rate that was pre-determined by the encoder. In this way, the transmission rate can be elastic in its response to changing network conditions.

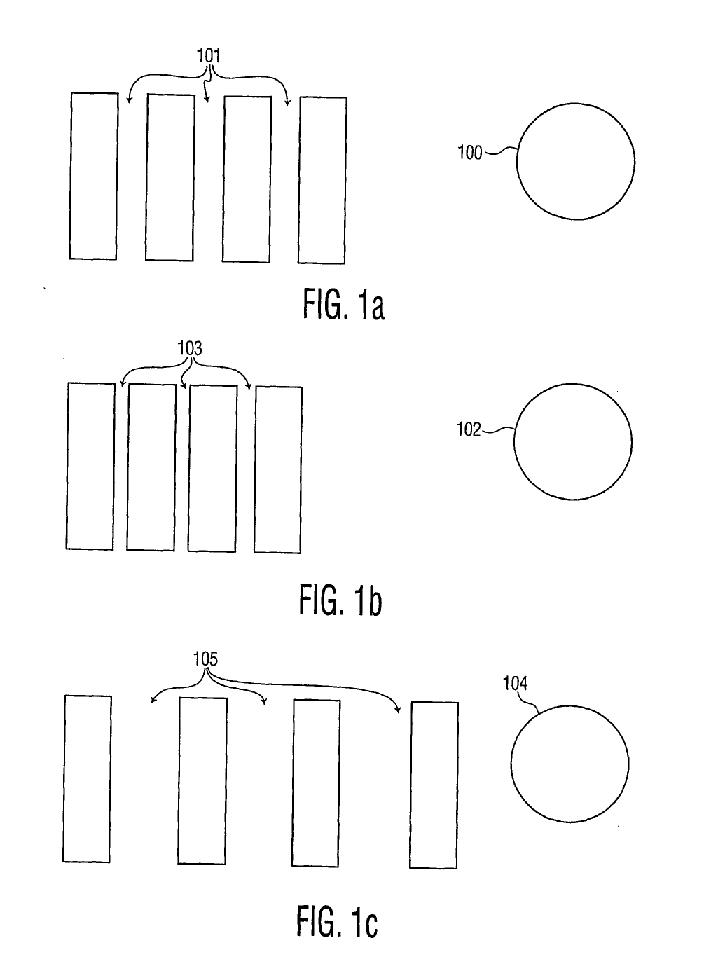

For example, assume the frequency for a real clock is 1 100, as illustrated in FIG. 1a. As illustrated in FIGS. 1b and 1c, respectively, the “Virtual Clock” can take a frequency either larger 102 or smaller 104 than 1. When the frequency of the “Virtual Clock” becomes larger 104 than 1, it will move faster than the real clock. Then, even if the timestamp sequences of a group of RTP packets remain unchanged, the intervals 101 between consecutive packets are shortened 103 by using the “Virtual Clock” to schedule them. The RTP packets appear at the network interface more frequently than normal, leading to an increase in the transmission rate over that pre-determined by the encoder. By contrast, when the “Virtual Clock” takes on a frequency smaller 104 than 1, the intervals 101 between consecutive packets are lengthened 105 and the packets appear at the network interface less frequently than normal, leading to a decrease in the transmission rate over that pre-determined by the encoder. Whenever there is a change to the frequency of the “Virtual Clock”, there will be a correspond change in the transmission rate. Therefore, the “Virtual Clock” according to the present invention, is an efficient system and method for streaming applications to adapt the transmission rate of a sequence of time-stamped RTP packets to network conditions.

Since the adjustment of the frequency of the “Virtual Clock” can be carried out over any time scale, particularly over small time scales, the “Virtual Clock” of the present invention can be used to achieve fine-grained rate adaptation and is the most important characteristic of “Virtual Clock”. By combining the “Virtual Clock” with other methods, such as in the example presented above, a streaming server is able to adapt its transmission rate over both large and small time scales, achieving better responsiveness to dynamic network conditions. Improved responsiveness leads to better network resource utilization and better video quality.

FIG. 1a illustrates packet arrival time at the network interface for a real clock.

FIG. 1b illustrates packet arrival time at the network interface for a “Virtual Clock” according to the present invention having a frequency greater than that of the real clock illustrated in FIG. 1a.

FIG. 1c illustrates packet arrival time at the network interface for a “Virtual Clock” according to the present invention having a frequency less than that of the real clock illustrated in FIG. 1a.

Assume f(t) is the frequency of the “Virtual Clock”, R₀(t) is the predetermined RTP packet rate, R_{L}(t) is the network bandwidth that is available to this streaming application, and the frequency of a real clock is 1. Also assume T is a time period in which both the real clock and the “Virtual Clock” advance the same distance in time space. That is

$$T = {\int }_{0}^{T} f ( t ) ⅆ t \qquad ( 1 )$$

In a preferred embodiment, the frequency of the “Virtual Clock” is configured as follows

$$f ( t ) = \{ \begin{matrix}{R}_{L} ( t ) / {R}_{0} ( t ) \\ 0\end{matrix} when \begin{matrix}t <= τ \\ t > τ\end{matrix} , where τ is determined by T = {\int }_{0}^{τ} f ( t ) ⅆ t \qquad ( 2 )$$

The formula (1) prescribes a general principle about how to configure the frequency of the “Virtual Clock” such that after every T time the two clocks re-synchronize, which is necessary for real-time streaming applications.

R₀(t) is obtained from the encoded contents that are stored in the server. R_{L}(t) 5 is measured by either the network interface driver at the server, or some dedicated network components residing in the network or at the receiver, and that calculates available bandwidth for the streaming application.

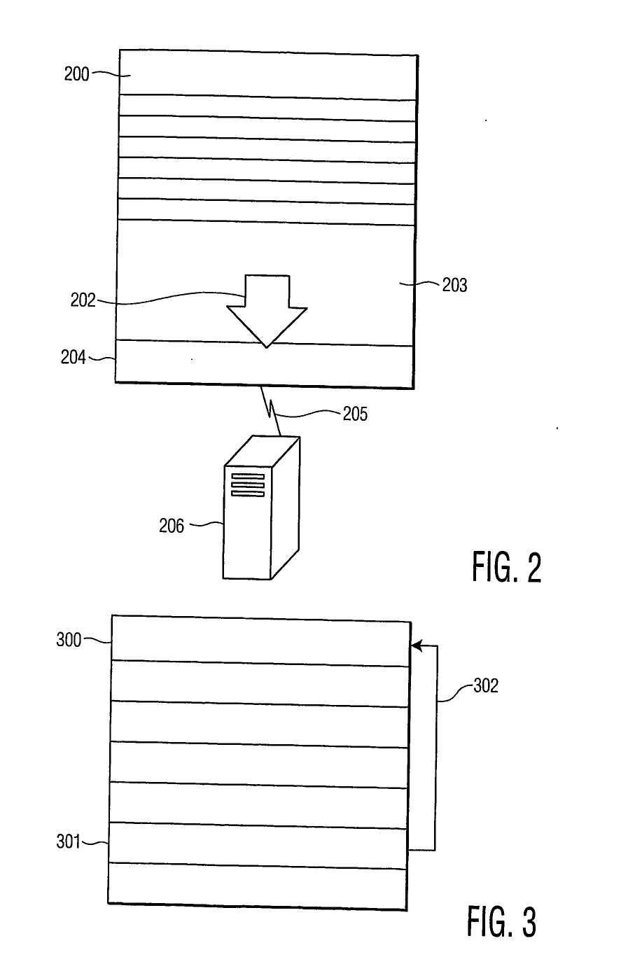

For example, in the instance of in-home 200 streaming over wireless illustrated in FIG. 2, due to radio frequency interference and channel fading, the wireless link capacity (such as R_{L}(t)) can change with time. In a preferred embodiment illustrated in FIG. 2, a monitor is placed into the wireless network driver 203 so that the driver measures R_{L}(t) and sends the measurement back 205 to the streaming server 206 allowing the transmission rate to be adapted to the wireless link status in real time. In this way, unnecessary packet drops can be avoided and the overall throughput can be improved.

In another preferred embodiment, in order to provide “Virtual Clock” service in parallel with real clock service to streaming applications by a host computer, a kernel function is implemented that has the form
void getvirtualclockfrequency(double demandbandwidth, double*virtualfequency).

When invoked, this function interacts with the network card driver or lower layer protocols to return a virtual frequency to the server. The server then maps the real clock to the “Virtual Clock”.

As illustrated in FIG. 3, the “Virtual Clock” of the present invention can be implemented at the application layer 300, but its frequency is controlled by a lower layer, in a preferred embodiment this is the link layer (or layer 2) 301. The link layer keeps monitoring the link status. If the available capacity is higher than a targeted capacity (a control reference), then the link layer will send up a clock frequency f(t)) 302 larger than 1, otherwise, smaller than 1.

The systems and methods of the present invention, as described above and shown in the drawings, provide for a ‘virtual ‘clock’ base on changing network conditions. It will be apparent to those skilled in the art that various modifications and variations can be made in the methods and systems of the present invention without departing from the spirit or scope of the invention. Thus, it is intended that the present invention include modifications and variations that are within the scope of the appended claims and their equivalents.

1. A communication network (207), comprising:
a real clock (100) that determines a pre-determined RTP packet transmission rate for a streaming application, R₀(t), based on encoded content;
a real clock (102) (104) having a frequency f(t) that determines a dynamic transmission rate for the streaming application;
a streaming server (206) that transmits a plurality of RTP packets at the determined dynamic transmission rate for the streaming application; and
a network component (203) that calculates available bandwidth R_{L}(t) (202) for the streaming application,
wherein f(t) is dynamically adjusted based on R_{L}(t) (202) and R₀(t).

2. The communication network (207) of claim 1, wherein the streaming server (206) is a multimedia streaming server.

3. The communication network (207) of claim 1, wherein the frequency f(t) of the real clock (102) (104) is configured as follows
if the real clock (100) is assumed to have a frequency f(t)=1 and T is a time period in which both the real clock (100) and the real clock (102) (104) advance the same distance in time space, that is
$$T = {\int }_{0}^{τ} f ( t ) ⅆ t$$
$$then$$
$$f ( t ) = \{ \begin{matrix}{R}_{L} ( t ) / {R}_{0} ( t ) \\ 0\end{matrix} when \begin{matrix}t <= τ \\ t > τ\end{matrix} \\ where \\ τ is determined by T = {\int }_{0}^{τ} f ( t ) ⅆ t and$$
R₀(t) is a pre-determined RTP packet rate based on content, wherein, after every T time the real clock (100) and the real clock (102) (104) re-synchronize.

4. The communication network (207) of claim 3, wherein R_{L}(t) is measured by one of a network interface driver at the streaming server (206), a set of one or more dedicated network components (203) residing in the network (207), and a set of one or more dedicated components at a receiver.

5. The communication network (207) of claim 4, wherein the network (207) is a wireless network and the set of one or more dedicated components at the receiver is a monitor placed into the wireless network driver such that the driver measures R_{L}(t) (202) and sends the measured R_{L}(t) (202) to the streaming server (206).

6. An apparatus for dynamically adjusting the transmission rate over a network (207) of a streaming server (206), comprising:
a real clock (100) that determines a pre-determined RTP packet transmission rate for a streaming application, R₀(t), based on encoded content;
a real clock (102) (104) having a frequency f(t) that determines a dynamic transmission rate for the streaming application; and
a network component (203) that calculates available bandwidth R_{L}(t) (202) for the streaming application,
wherein f(t) is dynamically adjusted based on R_{L}(t) (202) and f(t) (302).

7. The apparatus of claim 6, wherein the streaming server (206) is a multimedia streaming server.

8. The apparatus of claim 6, wherein the frequency f(t) of the real clock (102) (104) is configured as follows
if the real clock (100) is assumed to have a frequency f(t)=1 and T is a time period in which both the real clock (100) and the real clock (102) (104) advance the same distance in time space, that is
$$T = {\int }_{0}^{τ} f ( t ) ⅆ t$$
$$then$$
$$f ( t ) = \{ \begin{matrix}{R}_{L} ( t ) / {R}_{0} ( t ) \\ 0\end{matrix} when \begin{matrix}t <= τ \\ t > τ\end{matrix} \\ where \\ τ is determined by T = {\int }_{0}^{τ} f ( t ) ⅆ t and$$
R₀(t) is a pre-determined RTP packet rate based on content, wherein, after every T time the real clock (100) and the real clock (102) (104) re-synchronize.

9. The apparatus of claim 8, wherein R_{L}(t) is measured by one of a network interface driver at the streaming server (206), a set of one or more dedicated network components (203) residing in the network (207), and a set of one or more dedicated components at a receiver.

10. The apparatus of claim 9, wherein the network (207) is a wireless network (207) and the set of one or more dedicated components at the receiver is a monitor placed into the wireless network driver such that the driver measures R_{L}(t) (202) and sends the measured R_{L}(t) (202) to the streaming server (206).

11. A real clock (102) (104) for enabling a streaming server (206) to perform dynamic transmission rate adaptation, comprising:
a real clock (100) that determines a pre-determined RTP packet transmission rate for a streaming application, R₀(t), based on encoded content;
means for dynamically setting the frequency f(t) of the real clock (102) (104) that determines the rate of RTP packet transmission for the streaming application; and
a network component (203) that calculates available bandwidth R_{L}(t) (202) for the streaming application,
wherein f(t) (302) is dynamically adjusted based on R_{L}(t) (202) and R₀(t).

12. The real clock (102) (104) of claim 11, wherein the streaming server (206) is a multimedia streaming server.

13. The real clock (102) (104) of claim 11, wherein the means for determining the frequency f(t) of the real clock (102) (104) is a module that configures the frequency of f(t) as follows
if the real clock (100) is assumed to have a frequency f(t)=1 and T is a time period in which both the real clock (100) and the real clock (102) (104) advance the same distance in time space, that is
$$T = {\int }_{0}^{τ} f ( t ) ⅆ t$$
$$then$$
$$f ( t ) = \{ \begin{matrix}{R}_{L} ( t ) / {R}_{0} ( t ) \\ 0\end{matrix} when \begin{matrix}t <= τ \\ t > τ\end{matrix} \\ where \\ τ is determined by T = {\int }_{0}^{τ} f ( t ) ⅆ t and$$
R₀(t) is a pre-determined RTP packet rate based on content, wherein, after every T time the real clock (100) and the real clock (102) (104) re-synchronize.

14. The real clock (102) (104) of claim 11, wherein R_{L}(t) is measured by one of a network interface driver at the server, a set of one or more dedicated network components (203) residing in the network (207), and a set of one or more dedicated components at a receiver, and that calculates available bandwidth for the streaming application.

15. The real clock (102) (104) of claim 11, wherein the network (207) is a wireless network (207) and the set of one or more dedicated components at the receiver is a monitor placed into the wireless network driver such that the driver measures R_{L}(t) (202) and sends the measured R_{L}(t) (202) to the streaming server (206).

16. An operating system kernel function at an application layer (300) of a protocol that implements the real clock (102) (104) of claim 13,
wherein, the function interacts with a lower layer (301) of the protocol to return the virtual frequency f(t) (302).

17. A method for implementing a real clock (102) (104) for enabling a streaming server (206) to perform dynamic transmission rate adaptation for RTP packet transmission over a network (207), comprising the steps of:
providing a real clock (100) that determines a pre-determined RTP packet transmission rate for a streaming application, R₀(t), based on encoded content;
dynamically configuring the frequency f(t) of the real clock (102) (104) that determines the rate of RTP packet transmission for a streaming application; and
monitoring the available bandwidth R_{L}(t) (202) for the streaming application, dynamically adjusting f(t) (302) is based on R_{L}(t) (202) and R₀(t).

18. The method of claim 17, wherein the configuring step further comprises the steps of
a. if the real clock (100) is assumed to have a frequency f(t)=1 and T is a time period in which both the real clock (100) and the real clock (102) (104) advance the same distance in time space, that is
$$T = {\int }_{0}^{τ} f ( t ) ⅆ t$$
$$then calculating$$
$$f ( t ) = \{ \begin{matrix}{R}_{L} ( t ) / {R}_{0} ( t ) \\ 0\end{matrix} when \begin{matrix}t <= τ \\ t > τ\end{matrix} \\ where τ is determined by T = {\int }_{0}^{τ} f ( t ) ⅆ t and$$
R₀(t) is a pre-determined RTP packet rate based on content,
b. after every T time, re-synchronizing the real clock (100) and the real clock (102) (104).

19. The method of claim 18, further comprising the step of:
measuring R_{L}(t) by one of a network interface driver at the server, a set of one or more dedicated network components (203) residing in the network (207), and a set of one or more dedicated components at a receiver, and that calculates available bandwidth for the streaming application.

20. The method of claim 18, wherein
the network (207) is a wireless network (207);
the set of one or more dedicated components at the receiver is a monitor placed into the wireless network driver;
the monitoring step further comprises the steps
c. measuring R_{L}(t) (202) by the monitor R_{L}(t) (202); and
d. sending the measured R_{L}(t) (202) to the streaming server (206).
